(19) United States
(12) Patent Application Publication
(10) Pub. No.: US 2005/0121822 A1
(43) Pub. Date: Jun. 9, 2005

(54) Process for producing a coextruded, peelable polyester film

(76) Inventors: Herbert Peiffer, Mainz (DE); Bart Janssens, Wiesbaden (DE); Harald Mueller, Taunusstein (DE); Andreas Stopp, Ingelheim (DE)

Correspondence Address: PROPAT, L.L.C., 425-C SOUTH SHARON AMITY ROAD, CHARLOTTE, NC, 28211-2841, US

(21) Appl. No.: 10/984,728

(22) Filed: Nov. 9, 2004

(30) Foreign Application Priority Data
Nov. 10, 2003 (DE) 103 52 440.1

(51) Int. Cl. B29C 47/06

(52) U.S. Cl. 264/173.16; 264/235.8; 264/210.6; 264/210.5

(57) ABSTRACT

The invention relates to a process for producing a biaxially oriented polyester film which has a base layer (B) and has a heatsealable outer layer (A) that can be peeled from polyester, where the outer layer (A) includes from 60 to 99 % by weight of polyester which is composed of from 12 to 89 mol % of units derived from at least one aromatic dicarboxylic acid and of from 11 to 88 mol % of units derived from at least one aliphatic dicarboxylic acid, where the total of the molar percentages is 100, encompassing the steps of a) coextrusion of at least the base layer (B) and of the outer layer (A) to give an unoriented film, b) simultaneous, biaxial stretching of this unoriented film, and c) heat-setting of the stretched film.

### CROSS REFERENCE TO RELATED APPLICATIONS

This application claims priority to its parent application, German Patent Application 103 52 440.1, filed Nov. 10, 2003, hereby incorporated by reference herein in its entirety.

### FIELD OF THE INVENTION

The invention relates to a process for producing a coextruded, biaxially oriented polyester film which can be used, for example, as a lid film for containers (trays, yogurt cups, etc.). The polyester film includes a base layer (B) and at least one outer layer (A) applied to this base layer (B). The outer layer (A) is heatsealable and features, for example, good peeling properties from APET and CPET.

### BACKGROUND OF THE INVENTION

Ready-prepared meals which are enjoying increased growth rates in Europe are transferred to trays after their preparation (cf. FIG. 1). A film which is heatsealed to the edge of the tray seals the package and protects the ready-prepared meal from external influences. The ready-prepared meals are suitable, for example, for heating in a microwave and in a conventional oven. The ready-prepared meal and the packaging have to be “dual ovenable” (=suitable for microwave and conventional ovens). As a consequence of the temperatures existing in a conventional oven (up to 220° C.), particularly high demands are made on the packaging material (tray and lid film). Typical materials, suitable for microwave and conventional ovens, for the tray and the lid film are PET=polyethylene terephthalate, CPET=crystalline PET, APET=amorphous PET.

Tray

CPET, aluminum, cardboard coated with PET or with PET film or trays made of APET/CPET. Trays made of APET/CPET (cf. FIG. 1) includes externally a CPET layer and internally, i.e. facing toward the ready-prepared meal, an APET layer. The thick, crystalline CPET layer provides the stability of the tray, even at the comparatively high temperatures in a conventional oven. The amorphous PET essentially improves the adhesion of the film to the tray.

Lid film

Here, PET is generally used, which is dimensionally stable and remains solid enough even at 220° C. Materials such as PP or PE are ruled out owing to their low melting points. The demands on the lid film are best fulfilled by biaxially oriented polyester films.

When preparing the ready-prepared meal in an oven, the polyester film is removed by hand from the tray shortly before heating or shortly after heating. When this is done, the polyester film must on no account start to tear, start and continue to tear or tear off. The removal of the film from the tray without the film starting or continuing to tear or tearing off is also referred to in the foods industry as peeling. For this application, the polyester film therefore has to be not only heatsealable, but in particular also peelable. For a given material and given overall thickness of the film, the peelability of the film is determined mainly by the properties of the surface layer of the film which is sealed to the tray.

The peelability of films can be determined relatively simply in the laboratory using a tensile strain tester (for example from Zwick, Germany) (cf. FIG. 2). For this test, two strips of width 15 mm and length approx. 50 mm are first cut out of the polyester film and the tray and sealed to one another. The sealing layer of the polyester film is formed by the outer layer (A), and the sealing layer of the tray, for example, by the APET layer. The sealed strips are, as shown in FIG. 2, clamped into the clips of the tester. The “angle” between the film clamped in the upper clip and the tray strip is 180°. In this test, the clips of the tester are moved apart at a speed of 200 mm/min, and in the most favorable case the film is fully peeled off from the tray (cf., for example, ASTM-D 3330).

In this test, a distinction is to be drawn between essentially two different mechanisms.

In the first case, the tensile force rises rapidly in the course of the pulling procedure up to a maximum (cf. FIG. 3a) and then falls directly back to zero. When the maximum force is attained, the film starts to tear or, before delamination from the tray, tears off, which results in the force falling immediately back to zero. The film is in this case not peelable, since it is destroyed. The behavior of the film can rather be described as a kind of “welding” to the tray. The destruction of the film on removal from the tray is undesired, because this complicates the easy opening of the packaging without tools such as scissors or knives. In contrast, a peelable film is obtained when the tensile force or the peeling force rises up to a certain value (i.e. up to a certain plateau) and then remains approximately constant over the distance over which the two strips are sealed together (cf. FIG. 3b). In this case, the film does not start to tear, but rather can be peeled as desired off the tray with a low force input.

The size of the peeling force is determined primarily by the polymers used in the sealing layer (A) (cf. FIG. 4, polymer 1 and polymer 2). In addition, the size of the peeling force is dependent in particular on the heatsealing temperature employed. The peeling force generally rises with the heatsealing temperature. With increasing heatsealing temperature, the risk increases that the sealing layer might lose its peelability. In other words, a film which is peelable when a low heatsealing temperature is employed loses this property when a sufficiently high heatsealing temperature is employed. This behavior is to be expected in particular in the case of polymers which exhibit the characteristics shown in FIG. 4 for polymer 1. This behavior which tends to generally occur but is rather unfavorable for the application has to be taken into account when designing the sealing layer. It has to be possible to heatseal the film in a sufficiently large temperature range without the desired peelability being lost (cf. polymer 2 in FIG. 4). In practice, this temperature range is generally from 150 to 220° C., preferably from 150 to 200° C. and more preferably from 150 to 190° C.

The heatsealable and peelable layer is applied to the polyester film in accordance with the prior art, generally by means of offline methods (i.e. in an additional process step following the film production). This method initially produces a “standard polyester film” by a customary process. The polyester film produced in this way is then coated offline in a further processing step in a coating unit with a heatsealable and peelable layer. In this process, the heatsealable and peelable polymer is initially dissolved in an organic solvent. The final solution is then applied to the film by a suitable application process (knifecoater, patterned roller, die). In a downstream drying oven, the solvent is evaporated and the peelable polymer remains on the film as a solid layer.

Such an offline application of the sealing layer is comparatively expensive for several reasons. First, the film has to be coated in a separate step in a special apparatus. Second, the evaporated solvent has to be condensed again and recycled, in order thus to minimize pollution of the environment via the waste air. Third, complicated control is required to ensure that the residual solvent content in the coating is very low.

Moreover, in an economic process, the solvent can never be completely removed from the coating during the drying, in particular because the drying procedure cannot be of unlimited duration. Traces of the solvent remaining in the coating subsequently migrate via the film disposed on the tray into the foods where they can distort the taste or even damage the health of the consumer.

Various peelable, heatsealable polyester films which have been produced offline are offered on the market. The polyester films differ in their structure and in the composition of the top layer (A). Depending on their (peeling) properties, they have different applications. It is customary, for example, to divide the films from the application viewpoint into films having easy peelability (easy peel), having moderate peelability (medium peel) and having strong, robust peelability (strong peel). The essential quantifiable distinguishing feature between these films is the size of the particular peeling force according to FIG. 3b. A division is undertaken at this point as follows:

| | |
|---|---|
| Easy peelability | Peeling force in the range |
| (easy peel) | of from about 1 to 4 N per |
| | 15 mm of strip width |
| Moderate peelability | Peeling force in the range |
| (medium peel) | from about 3 to 8 N per 15 mm |
| | of strip width |
| Strong, robust peelability | Peeling force in the range |
| (strong peel) | of more than 5 N per 15 mm |
| | of strip width |

Processes for producing sealable PET films are known.

EP-A 0 379 190 describes a biaxially oriented, multilayer polyester film comprising a carrier layer of polyester and at least one sealing layer of a polyester composition. The polyester film can be produced by employing coextrusion technology, inline coating, inline lamination or employing suitable combinations of the technologies mentioned. In inline coating, the polymers of the sealing layer are applied to the carrier layer in the form of a dispersion or solution. In inline lamination, the polymers of the sealing layer are applied to the carrier layer in the form of extruded melt, for example between the two stretching steps.

The sealing layer may comprise aliphatic and aromatic dicarboxylic acids and also aliphatic diols. The polymer for the sealing layer comprises two different polyesters A and B, of which at least one (polyester B) contains aliphatic dicarboxylic acids and/or aliphatic diols. The sealing energy which is measured between two sealing film layers facing each other and bonded together (=fin sealing) is more than 400 g_{force}·cm/15 mm (=more than 4 N·cm/15 mm), and the sealing film layer may comprise inorganic and/or organic fine particles which are insoluble in the polyester, in which case the fine particles are present in an amount of from 0.1 to 5% by weight, based on the total weight of the sealing film layer. Although the film features good peeling properties (having plateau character in the peeling diagram, see above) with respect to itself (i.e. sealing layer with respect to sealing layer), there is no information about the peeling performance with respect to trays made of APET, CPET and APET/CPET. In particular, the film of this invention is in need of improvement in its producibility and its processibility.

WO A-96/19333 describes a process for producing peelable films, in which the heatsealable, peelable layer is applied inline to the polyester film. In the process, comparatively small amounts of organic solvents are used. The heatsealable, peelable layer comprises a copolyester which has
from 40 to 90 mol % of an aromatic dicarboxylic acid,
from 10 to 60 mol % of an aliphatic dicarboxylic acid,
from 0.1 to 10 mol % of a dicarboxylic acid containing a free acid group or a salt thereof,
from 40 to 90 mol % of a glycol containing from 2 to 12 carbon atoms and
from 10 to 60 mol % of a polyalkyldiol.

The coating is applied to the film from an aqueous dispersion or a solution which contains up to 10% by weight of organic solvent. The process is restricted with regard to the polymers which can be used and the layer thicknesses which can be achieved for the heatsealable, peelable layer. The maximum achievable layer thickness is specified as 0.5 μm. The maximum seal seam strength is low, and is from 500 to 600 g/25 mm², or [(from 500 to 600)/170] N/15 mm of film width.

WO 02/059186 A1 describes a process for producing peelable films, in which the heatsealable, peelable layer is applied inline to the polyester film. The method employed is melt-coating, and it is preferably the longitudinally stretched film which is coated with the heatsealable, peelable polymer. The heatsealable polymer contains polyesters based on aromatic and aliphatic acids, and also based on aliphatic diols. The copolymers disclosed in the examples have glass transition temperatures of below -10 C; such copolyesters are too soft, which is why they cannot be oriented in customary roll stretching methods (adhesion to the rolls). In WO 02/059186 A1, the melt-coating known per se is delimited from the extrusion coating known per se technically and by the viscosity of the melt. A disadvantage of the melt-coating is that only comparatively fluid polymers (max. 50 Pa.s) having a low molecular weight can be used. This results in disadvantageous peeling properties of the film. Moreover, the coating rate in this process is limited, which makes the production process uneconomic. With regard to quality, faults are observed in the appearance of the film which are visible, for example, as coating streaks. In this process, it is also difficult to obtain a uniform thickness of the sealing layer over the web width of the film, which in turn leads to nonuniform peeling characteristics.

It is common to the prior art documents mentioned that polymers are used for the sealable and peelable layer which feature a very low glass transition temperature. Such polymers have a particular tendency to adhere to other materials or to remain adhesively bonded to them. A typical example thereof is the adhesion of these polymers to the metallic or ceramic surfaces of rolls, especially those of the longitudinal stretching in the production of biaxially oriented polyester films.

According to abovementioned processes, this disadvantage is avoided by selecting, instead of the coextrusion technology which is very advantageous per se, the coating technology which is less advantageous per se (because it is generally more expensive).

### SUMMARY OF THE INVENTION

It is an object of the present invention to provide a process for producing a heatsealable and peelable, biaxially oriented polyester film for which one or more of the aforementioned difficulties are overcome. In particular, it is an aim to provide an economic process for the production of a heatsealable and peelable polyester film in which the use of solvents which are controversial from a toxicological and environmental point of view is dispensed with from the outset. The film produced by means of the process according to the invention should in particular feature outstanding peeling properties with respect to food containers (trays, cups, etc.), especially those made of CPET, APET or the APET side of trays made of APET/CPET. In addition, it is an object of the invention to provide, with the aid of the process according to the invention, a film which has the following features:
a) easy to moderate peelability (easy peel to medium peel) with respect to CPET or the APET side of trays made of APET/CPET. The peeling force should be in the range from 1.5 to 8 N per 15 mm, preferably in the range from 2.0 to 8 N per 15 mm and more preferably in the range from 2.5 to 8 N per 15 mm, of film strip width;
b) the heatsealable and peelable layer does not contain any organic solvent residues;
c) the heatsealable and peelable layer, with respect to CPET or the APET side of APET/CPET trays has a minimum sealing temperature of 165° C., preferably 155° C., more preferably 150° C., and a maximum sealing temperature of generally 220° C., preferably 200° C. and more preferably 190° C.;
d) it is produced employing processes in which no organic solvents are used from the outset;
e) the film can be produced economically. This also means, for example, that the film can be produced using processes in which the possibility of adhesion of the film to rolls is avoided from the outset;
f) good adhesion (preferably greater than 2 N/15 mm of film width) between the individual layers of the film is ensured for their practical application;
g) the optical properties of the film are good. This means, for example, low opacity in the case of a transparent film (preferably less than 20%) and high gloss (preferably >70 for the sealable side and preferably >100 for the side opposite the sealable side; each measured at angle of incidence 20°) of the film;
h) in the course of the production of the film, it is ensured that the regrind can be fed back to the extrusion in an amount of up to approx. 60% by weight, without significantly adversely affecting the physical (the tensile strain at break of the film in both directions should not decrease by more than 10%), but especially the optical properties of the film.

In addition, care should be taken that the film can be processed on high-speed machines. On the other hand, the known properties which distinguish polyester films should at the same time not deteriorate. These include, for example, the good mechanical (the modulus of elasticity of the biaxially stretched films in both orientation directions should be greater than 3500 N/mm², preferably greater than 3800 N/mm² and more preferably greater than 4200 N/mm²) and the thermal properties (the shrinkage of the biaxially stretched films in both orientation directions should not be greater than 3%, preferably not greater than 2.8% and more preferably not greater than 2.5%), the winding performance and the processibility of the film, in particular in the printing, laminating or in the coating of the film with metallic or ceramic materials.

Heatsealable refers here to the property of a multilayer polyester film which has at least one base layer (B) and has at least one top layer (=heatsealable top layer) which can be bonded by means of sealing jaws by applying heat (140 to 220° C.) and pressure (2 to 5 bar) within a certain time (0.2 to 2 s) to itself (fin sealing), or to a substrate made of a thermoplastic (=lap sealing, here in particular to CPET or the APET side of APET/CPET trays), without the carrier layer (=base layer) itself becoming plastic. In order to achieve this, the polymer of the sealing layer generally has a distinctly lower melting point than the polymer of the base layer. When the polymer used for the base layer is, for example, polyethylene terephthalate having a melting point of 254° C., the melting point of the heatsealable layer is generally less than 230° C., in the present case preferably less than 210° C. and more preferably less than 190° C.

Peelable refers here to the property of the inventive polyester film which comprises at least one layer (=heatsealable and peelable top layer (A)), after heatsealing to a substrate (here essentially CPET or the APET side of an APET/CPET tray), of being able to be pulled again from the substrate in such a way that the film neither starts to tear nor tears off. The bond of heatsealable film and substrate breaks in the seam between the heatsealed layer and substrate surface when the film is removed from the substrate (cf. also Ahlhaus, O. E.: Verpackung mit Kunststoffen [Packaging with plastics], Carl Hanser Verlag, p. 271, 1997, ISBN 3-446-17711-6). When the film heatsealed to a test strip of the substrate is removed in a tensile strain testing instrument at a peeling angle of 180° in accordance with FIG. 2, the tensile strain behavior of the film according to FIG. 3b is then obtained. On commencement of the peeling of the film from the substrate, the force required for this purpose rises, according to FIG. 3b, up to a certain value (e.g. 4 N/15 mm) and then remains approximately constant over the entire peeling operation, but is subject to larger or smaller variations (approx. ±20%).

### BRIEF DESCRIPTION OF THE DRAWINGS

FIG. 1 is a schematic illustration of an exemplary sealed tray;

FIG. 2 is a schematic illustration of a tensile strain measuring technique;

FIG. 3a is an exemplary diagram of tensile strain at break for a film having weldable behavior;

FIG. 3b is an exemplary diagram of tensile strain at break for a film having peelable behavior;

FIG. 4 is an exemplary diagram of tensile strain at break for films having weldable and peelable behavior;

FIG. 5 is an exemplary diagram of the correlation between sealing temperature and peeling force.

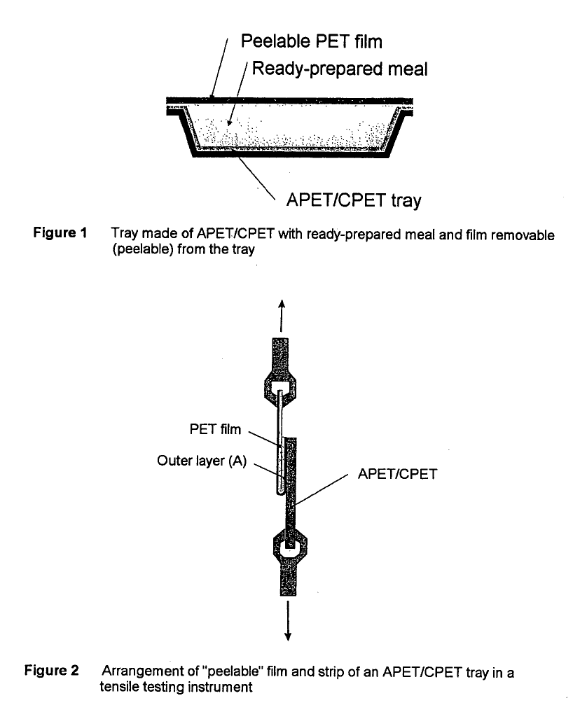

### DETAILED DESCRIPTION OF THE INVENTION

The object is achieved by providing a process for the production of a biaxially oriented polyester film which has a base layer (B) and has a heatsealable outer layer (A) that can at least be peeled from polyester (especially APET and/or CPET), the process including at least the following steps:
a) coextrusion of at least a base layer (B) and of the heatsealable and peelable outer layer (A) to give an unoriented film,
b) simultaneous, biaxial stretching of this unoriented film;
c) heat-setting of the simultaneously stretched film; and the outer layer (A) comprising from 60 to 99% by weight of polyester (based on the mass of (A)) which is composed of from 12 to 89 mol % of units derived from at least one aromatic dicarboxylic acid and of from 11 to 88 mol % of units derived from at least one aliphatic dicarboxylic acid, where the sum of the dicarboxylic acid-derived molar percentages is 100.

The layer thickness of the outer layer (A) d_{A} is preferably from 1.0 to 7 μm.

The abovementioned parameters are each to be regarded as preferred values.

The process is based essentially on the production of a coextruded, unstretched film comprising at least one base layer (B) and at least one heatsealable and peelable outer layer (A) and the simultaneous biaxial stretching of this film with subsequent heat-setting and winding-up of the film.

The material of the outer layer (A) includes predominantly a polyester. The polyester is composed of units which are derived from aromatic and aliphatic dicarboxylic acids. The units which derive from the aromatic dicarboxylic acids are present in the polyester in an amount of from 12 to 89 mol %, in particular from 30 to 84 mol %, more preferably from 40 to 82 mol %. The units which derive from the aliphatic dicarboxylic acids are present in the polyester preferably in an amount of from 11 to 88 mol %, in particular from 16 to 70 mol %, more preferably from 18 to 60 mol %, and the molar percentages always add up to 100%. The diol units corresponding thereto likewise always make up 100 mol %.

Preferred aliphatic dicarboxylic acids are succinic acid, pimelic acid, azelaic acid, sebacic acid, glutaric acid and adipic acid. Especially preferred are azelaic acid, sebacic acid and adipic acid.

Preferred aromatic dicarboxylic acids are terephthalic acid, isophthalic acid and 2,6-naphthalenedicarboxylic acid, in particular terephthalic acid and isophthalic acid.

Preferred diols are ethylene glycol, butylene glycol and neopentyl glycol.

In general, the polyester comprises the following dicarboxylates and alkylenes, based in each case on the total amount of dicarboxylate or total amount of alkylene:
from 12 to 89 mol %, preferably from 25 to 79 mol % and more preferably from 30 to 72 mol %, of terephthalate;
from 0 to 25 mol %, preferably from 5 to 20 mol % and more preferably from 10 to 20 mol %, of isophthalate;
from 11 to 88 mol %, preferably from 16 to 70 mol % and more preferably from 17 to 58 mol %, of azelate;
from 0 to 50 mol %, preferably from 0 to 40 mol % and more preferably from 0.2 to 30 mol %, of sebacate;
from 0 to 50 mol %, preferably from 0 to 40 mol % and more preferably from 0 to 30 mol %, of adipate;
more than 30 mol %, preferably more than 40 mol % and more preferably more than 50 mol %, of ethylene or butylene.

In addition, the material of the outer layer (A) may contain up to 10% by weight of further additives, auxiliaries and/or other additives which are customarily used in polyester film technology.

In a favorable embodiment, the material of the outer layer (A) additionally contains from 2 to 30% by weight, preferably from 5 to 25% by weight and more preferably from 7 to 20% by weight, of a polymer which is incompatible with polyester (anti-PET polymer).

It has been found to be appropriate to produce the main polyester of the outer layer (A) from two separate polyesters I and II which are fed to the extruder for the formation of this layer as a mixture.

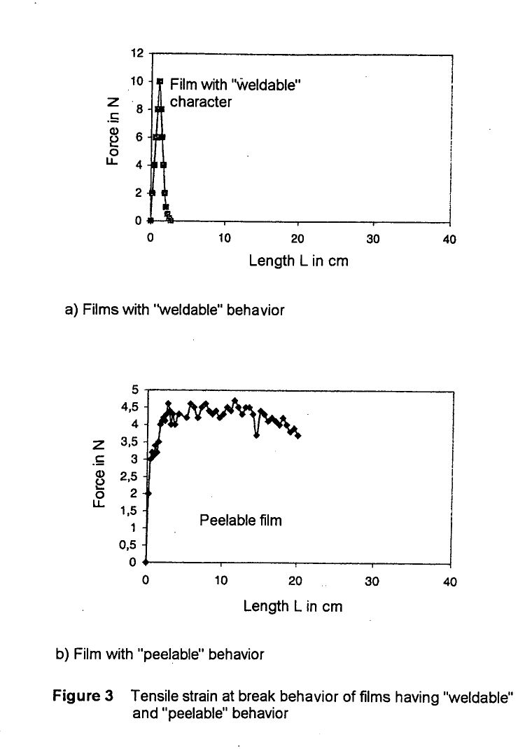

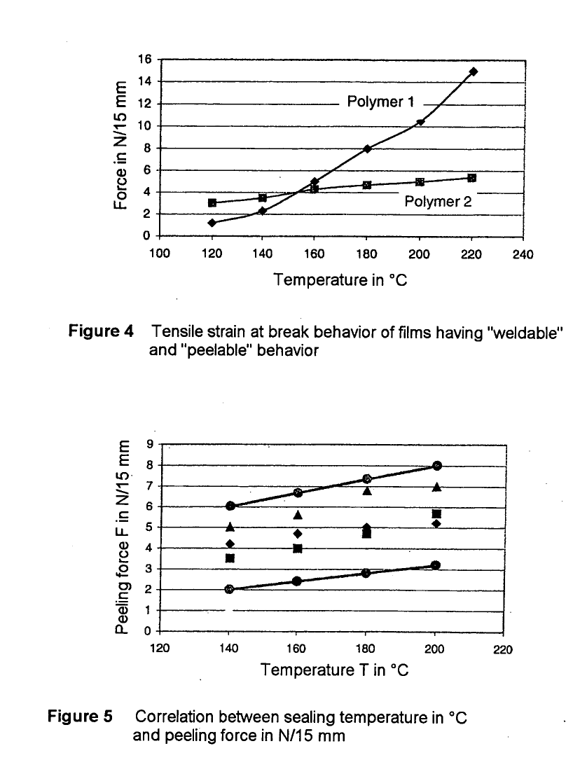

The heatsealable and peelable outer layer (A) is distinguished by characteristic features. It has a sealing commencement temperature (=minimum sealing temperature) with respect to CPET or the APET side of APET/CPET trays of not more than 165° C., preferably not more than 160° C. and more preferably not more than 155° C., and a seal seam strength with respect to CPET or the APET side of APET/CPET trays preferably of at least 1.5 N, in particular at least 2.0 N, more preferably at least 2.5 N (always based on 15 mm film width). The heatsealable and peelable outer layer (A), with respect to CPET or the APET side of APET/CPET trays, has a max. sealing temperature of generally 220° C., preferably 200° C. and more preferably 190° C., and a film which is peelable with respect to CPET or the APET side of APET/CPET trays is obtained within the entire sealing range. In other words, this film in the 180° tensile experiment according to FIG. 2 provides a curve according to FIG. 3b. The term trays can be equated with materials in general.

For the preferred, abovementioned ranges, the peeling results can also be described numerically. According to the present experimental investigations, the peeling results can be correlated to one another simply by the following relationship between the sealing temperature (T=δ in ° C.) and the peeling force (in N/15 mm)
0.02·δ/° C.−0.8≦peeling force F/N per 15 nm≦0.033·δ/° C.+1.4

This relationship is depicted graphically in FIG. 5 for illustration.

The coextruded and simultaneously stretched, biaxially oriented film of the present invention has a base layer (B) and at least one inventive outer layer (A). In this case, the film has a two-layer structure. In a preferred embodiment, the film has a three- or more than three-layer structure. In the case of the particularly preferred three-layer embodiment, it includes the base layer (B), the inventive outer layer (A) and an outer layer (C) on the opposite side to the outer layer (A); A-B-C film structure. In a four-layer embodiment, the film comprises an intermediate layer (D) between the base layer (B) and the outer layer (A) or (C).

The base layer of the film includes at least 80% by weight of thermoplastic polyester, based on the weight of the base layer (B). Suitable for this purpose are, for example, polyesters of ethylene glycol and terephthalic acid (=polyethylene terephthalate, PET), of ethylene glycol and naphthalene-2,6-dicarboxylic acid (=polyethylene 2,6-naphthalate, PEN), of 1,4-bishydroxy-methylcyclohexane and terephthalic acid (=poly-1,4-cyclohexanedimethylene terephthalate, PCDT) and also of ethylene glycol, naphthalene-2,6-dicarboxylic acid and biphenyl-4,4′-dicarboxylic acid (=polyethylene 2,6-naphthalate bibenzoate, PENBB). Preference is given to polyesters which contain ethylene units and includes, based on the dicarboxylate units, at least 90 mol %, more preferably at least 95 mol %, terephthalate or 2,6-naphthalate units. The remaining monomer units stem from other dicarboxylic acids or diols. Advantageously, copolymers or mixtures or blends of the homo- and/or copolymers mentioned can also be used for the base layer (B). In the specification of the amounts of the dicarboxylic acids, the total amount of all dicarboxylic acids is 100 mol %. Similarly, the total amount of all diols also adds up to 100 mol %.

Suitable other aromatic dicarboxylic acids are preferably benzenedicarboxylic acids, naphthalene-dicarboxylic acids (for example naphthalene-1,4- or 1,6-dicarboxylic acid), biphenyl-x,x′-dicarboxylic acids (in particular biphenyl-4,4′-dicarboxylic acid), diphenylacetylene-x,x′-dicarboxylic acids (in particular diphenylacetylene-4,4′-dicarboxylic acid) or stilbene-x,x′-dicarboxylic acids. Of the cycloaliphatic dicarboxylic acids, mention should be made of cyclo-hexanedicarboxylic acids (in particular cyclohexane-1,4-dicarboxylic acid). Of the aliphatic dicarboxylic acids, the (C₃-C₁₉)alkanedioic acids are particularly suitable, and the alkane moiety may be straight-chain or branched.

Suitable other aliphatic diols are, for example, diethylene glycol, triethylene glycol, aliphatic glycols of the general formula HO—(CH₂)ₙ—OH where n is an integer from 3 to 6 (in particular propane-1,3-diol, butane-1,4-diol, pentane-1,5-diol and hexane-1,6-diol) or branched aliphatic glycols having up to 6 carbon atoms, cycloaliphatic, optionally heteroatom-containing diols having one or more rings. Of the cycloaliphatic diols, mention should be made of cyclohexanediols (in particular cyclohexane-1,4-diol). Suitable other aromatic diols correspond, for example, to the formula HO—C₆H₄—X—C₆H₄—OH where X is —CH₂—, —C(CH₃)₂—, —C(CF₃)₂—, —O—, —S— or —SO₂—. In addition, bisphenols of the formula HO—C₆H₄—C₆H₄—OH are also very suitable.

It is particularly advantageous for a polyester copolymer based on terephthalate and small amounts (preferably <5 mol %) of isophthalic acid or based on terephthalate and small amounts (preferably <5 mol %) of naphthalene-2,6-dicarboxylic acid to be used in the base layer (B). In this case, the producibility of the film and the optical properties of the film are particularly good. The base layer (B) then comprises substantially a polyester copolymer which is composed predominantly of terephthalic acid and isophthalic acid units and/or terephthalic acid and naphthalene-2,6-dicarboxylic acid units and of ethylene glycol units. The particularly preferred copolyesters which provide the desired properties of the film are those which are composed of terephthalate and isophthalate units and of ethylene glycol units.

The polyesters can be prepared for example by the transesterification process. In this process, the starting materials are dicarboxylic esters and diols which are reacted with the customary transesterification catalysts such as salts of zinc, calcium, lithium and manganese. The intermediates are then polycondensed in the presence of generally customary polycondensation catalysts such as antimony trioxide, titanium oxides or esters, or else germanium compounds. The preparation may equally be by the direct esterification process in the presence of polycondensation catalysts. This process starts directly from the dicarboxylic acids and the diols.

The film of the present invention has an at least two-layer structure. In that case, it includes the base layer (B) and the inventive sealable and peelable outer layer (A) applied to it by coextrusion.

The sealable and peelable outer layer (A) applied to the base layer (B) by coextrusion is composed predominantly, i.e. preferably to an extent of at least 60% by weight, of polyesters.

According to the invention, the heatsealable and peelable outer layer (A) comprises polyesters based on aromatic and aliphatic acids and preferably aliphatic diols.

In the preferred embodiment, polyesters are copolyesters or blends of homo- and copolyesters or blends of different copolyesters which are formed on the basis of aromatic and aliphatic dicarboxylic acids and aliphatic diols.

Examples of the aromatic dicarboxylic acids which can be used in accordance with the invention are terephthalic acid, isophthalic acid, phthalic acid and naphthalene-2,6-dicarboxylic acid.

Examples of the aliphatic dicarboxylic acids which can be used in accordance with the invention are succinic acid, glutaric acid, adipic acid, pimelic acid, suberic acid, azelaic acid and sebacic acid.

Examples of the aliphatic diols which can be used in accordance with the invention are ethylene glycol, 1,3-propanediol, 1,3-butanediol, 1,4-butanediol, 1,5-pentanediol, 2,2-dimethyl-1,3-propanediol, diethylene glycol, triethylene glycol and 1,4-cyclohexanedimethanol.

The polyester for the outer layer (A) is preferably prepared from two polyesters I and II.

The proportion of the polyester I which includes one or more aromatic dicarboxylates and one or more aliphatic alkylenes in the outer layer (A) is preferably from 0 to 50% by weight. In the preferred embodiment, the proportion of the polyester I is from 5 to 45% by weight and, in the particularly preferred embodiment, it is from 10 to 40% by weight.

In general, the polyester I of the inventive outer layer (A) is based on the following dicarboxylates and alkylenes, based in each case on the total amount of dicarboxylate or total amount of alkylene:
from 70 to 100 mol %, preferably from 72 to 95 mol % and more preferably from 74 to 93 mol %, of terephthalate;
from 0 to 30 mol %, preferably from 5 to 28 mol % and more preferably from 7 to 26 mol %, of isophthalate;
more than 50 mol %, preferably more than 65 mol % and more preferably more than 80 mol %, of ethylene units.

Any remaining fractions present stem from other aromatic dicarboxylic acids and other aliphatic diols, as have already been listed above for the base layer (B).

Very particular preference is given to those copolyesters in which the proportion of terephthalate units is from 74 to 88 mol %, the corresponding proportion of isophthalate units is from 12 to 26 mol % (the dicarboxylate fractions adding up to 100 mol %) and the proportion of ethylene units is 100 mol %. In other words, they are polyethylene terephthalate/isophthalate.

In a further preferred embodiment, the polyester I includes a mixture which comprises a copolyester composed of terephthalate, isophthalate and ethylene units, and an aromatic polyester homopolymer, e.g. a polybutylene terephthalate.

According to the present invention, the proportion of polyester II in the outer layer (A) is from 50 to 100% by weight. In the preferred embodiment, the proportion of polyester II is from 55 to 95% by weight and in the particularly preferred embodiment it is from 60 to 90% by weight.

The polyester II preferably includes a copolymer of aliphatic and aromatic acid components, in which the aliphatic acid components are preferably from 20 to 90 mol %, in particular from 30 to 70 mol % and more preferably from 35 to 60 mol %, based on the total acid amount of the polyester II. The remaining dicarboxylate content up to 100 mol % stems from aromatic acids, preferably terephthalic acid and/or isophthalic acid, and also, among the glycols, from aliphatic or cycloaliphatic or aromatic diols, as have already been described in detail above with regard to the base layer.

In general, the polyester II of the inventive outer layer (A) is based at least on the following dicarboxylates and alkylenes, based in each case on the total amount of dicarboxylate or the total amount of alkylene:
from 20 to 90 mol %, preferably from 30 to 70 mol % and more preferably from 35 to 60 mol %, of azelate;
from 0 to 50 mol %, preferably from 0 to 45 mol % and more preferably from 0 to 40 mol %, of sebacate;
from 0 to 50 mol %, preferably from 0 to 45 mol % and more preferably from 0 to 40 mol %, of adipate;
from 10 to 80 mol %, preferably from 20 to 70 mol % and more preferably from 30 to 60 mol %, of terephthalate;
from 0 to 30 mol %, preferably from 3 to 25 mol % and more preferably from 5 to 20 mol %, of isophthalate;
more than 30 mol %, preferably more than 40 mol % and more preferably more than 50 mol %, of ethylene or butylene.

Any remaining fractions present stem from other aromatic dicarboxylic acids and other aliphatic diols, as have already been listed above for the base layer (B), or else from hydroxycarboxylic acids such as hydroxybenzoic acid or the like.

The presence of preferably at least 10 mol % of aromatic dicarboxylic acid ensures that the polymer II can be processed without adhesion, for example in the intake region of the extruder for the film (A).

The outer layer (A) preferably comprises a mixture of the polyesters I and II. Compared to the use of only one polyester with comparable components and comparable proportions of the components, a mixture has the following advantages:
a) The mixture of the two polyesters I and II, from the aspect of the particular glass transition temperatures (T_{g}), is easier to process (to extrude). As investigations have shown, the mixture of a polymer having a high T_{g} (polyester I) and a polymer having a low T_{g} (polyester II) has a lesser tendency to adhere in the intake of the coextruder than a single polymer having a correspondingly mixed T_{g}.
b) The polymer production is simpler, because the number of metering stations available for the starting materials is generally not unlimited.
c) Moreover, from a practical aspect, the desired peeling properties can be adjusted more individually with the mixture than when a single polyester is used.
d) The addition of particles (see below) is also simpler in the case of polyester I than in the case of polyester II.

Appropriately, the glass transition temperature of polyester I is more than 50° C. The glass transition temperature of polyester I is preferably more than 55° C. and more preferably more than 60° C. When the glass transition temperature of polyester I is less than 50° C., the film in some circumstances cannot be produced in a reliable process. The tendency of the outer layer (A) to adhere, for example to the metallic walls of the extruder, may be so high that blockages in the extruder have to be expected.

Appropriately, the glass transition temperature of polyester II is less than 20° C. The glass transition temperature is preferably less than 15° C. and more preferably less than 10° C. When the glass transition temperature of polyester II is greater than 20° C., the film has an increased tendency to start to tear or tear off when pulled off the tray, which is undesired.

In a further favorable embodiment of the invention, the heatsealable and peelable outer layer (A) additionally comprises a polymer which is incompatible with polyester (anti-PET polymer). The proportion of the polyester-incompatible polymer (anti-PET polymer) is preferably from 2 to 30% by weight, based on the mass of the outer layer (A). In a preferred embodiment, the proportion of the polymer is from 5 to 25% by weight and in the particularly preferred embodiment it is from 7 to 20% by weight, likewise based on the mass of the outer layer (A).

Examples of suitable incompatible polymers (anti-PET polymers) are polymers based on ethylene (e.g. LLDPE, HDPE), propylene (PP), cycloolefins (CO), amides (PA) or styrene (PS). In a preferred embodiment, the polyester-incompatible polymer (anti-PET polymer) used is a copolymer. Examples thereof are copolymers based on ethylene (C2/C3, C2/C3/C4 copolymers), propylene (C2/C3, C2/C3/C4 copolymers), butylene (C2/C3, C2/C3/C4 copolymers) or based on cycloolefins (norbornene/ethylene, tetracyclododecene/ethylene copolymers). In one of the particularly preferred embodiments, the polyester-incompatible polymer (anti-PET polymer) is a cycloolefin copolymer (COC). Such cycloolefin copolymers are described, for example, in EP-A 1 068 949 or in JP 05-009319, which are incorporated herein by reference.

Among the cycloolefin copolymers, preference is given in particular to those which comprise polymerized units of polycyclic olefins having a norbornene basic structure, more preferably norbornene or tetracyclododecene. Particular preference is given to cycloolefin copolymers (COC) which contain polymerized units of acyclic olefins, in particular ethylene. Very particular preference is given to norbornene/ethylene and tetracyclododecene/ethylene copolymers which contain from 5 to 80% by weight of ethylene units, preferably from 10 to 60% by weight of ethylene units (based on the mass of the copolymer).

The cycloolefin polymers generally have glass transition temperatures between −20 and 400° C. For the invention, particularly suitable cycloolefin copolymers (COC) are those which have a glass transition temperature of less than 160° C., preferably less than 120° C. and more preferably less than 80° C. The glass transition temperature should preferably be above 50° C., preferably above 55° C. and in particular above 60° C. The viscosity number (decalin, 135° C., DIN 53 728) is appropriately between 0.1 and 200 ml/g, preferably between 50 and 150 ml/g. Films which comprise a COC having a glass transition temperature of less than 80° C., compared to those which comprise a COC having a glass transition temperature of greater than 80° C., feature improved optical properties, especially low opacity.

The cycloolefin copolymers (COC) are prepared, for example, by heterogeneous or homogeneous catalysis with organometallic compounds and is described in a multitude of documents. Suitable catalyst systems based on mixed catalysts of titanium or vanadium compounds in combination with aluminum organyls are described in DD 109 224, DD 237 070 and EP-A-0 156 464.

EP-A-0 283 164, EP-A-0 407 870, EP-A-0 485 893 and EP-A-0 503 422 describe the preparation of cycloolefin copolymers (COC) with catalysts based on soluble metallocene complexes. Particular preference is given to using cycloolefin copolymers prepared with catalysts which are based on soluble metallocene complexes. Such COCs are commercially obtainable; for example Topas® (Ticona, Frankfurt).

When the proportion of the polyester-incompatible polymer (anti-PET polymer) is less than 2% by weight, based on the mass of the outer layer (A), there is under some circumstances no positive influence of the polymer on the removal performance of the film from the tray. When the film is removed from the tray, the film may still have a tendency to start to tear or to tear off. Especially at relatively high sealing temperatures (>160° C.), this effect as a result of the addition of polyester-incompatible polymer (anti-PET polymer) becomes particularly apparent. Even in that case, films produced in accordance with the invention do not start to tear or tear off on removal from the tray. On the other hand, the proportion of polyester-incompatible polymer (anti-PET polymer) should not exceed 30% by weight, since the opacity of the film otherwise becomes too high.

To improve the handling of the film, the processibility of the film, but especially also to improve the removal performance of the film from the tray, it is advantageous to further modify the heatsealable and peelable outer layer (A).

This is best done with the aid of suitable antiblocking agents (particles) which are optionally added to the sealing layer and in such amounts that the removal performance of the film from the tray is further improved, blocking of the film is prevented and the processing performance of the film is optimized.

It has been found to be favorable for at least the outer layer (A) to include particles in a certain size, in a certain concentration and in a certain distribution. In addition, mixtures of two and more different particle systems or mixtures of particle systems in the same chemical composition but different particle size may also be added to the outer layer (A).

Customary antiblocking agents (also referred to as pigments or particles) are inorganic and/or organic particles, for example calcium carbonate, amorphous silica, talc, magnesium carbonate, barium carbonate, calcium sulfate, barium sulfate, lithium phosphate, calcium phosphate, magnesium phosphate, alumina, lithium fluoride, or calcium, barium, zinc or manganese salts of the dicarboxylic acids used, carbon black, titanium dioxide, kaolin or crosslinked polystyrene or acrylate particles. The particles may be added to the layer in the particular advantageous concentrations, for example as a glycolic dispersion during the polycondensation or via masterbatches in the course of extrusion.

Particles which are preferred in accordance with the invention are synthetic, amorphous SiO₂ particles in colloidal form. These particles are bound into the polymer matrix in an outstanding manner and generate only few vacuoles (cavities). Vacuoles are formed at the particles in the biaxial orientation, generally cause opacity and are therefore undesired for the present invention. To (synthetically) produce the SiO₂ particles (also known as silica gel), sulfuric acid and sodium silicate are initially mixed with one another under controlled conditions to form hydrosol. This eventually forms a hard, transparent mass which is known as a hydrogel. After separation of the sodium sulfate formed as a by-product by a washing process, the hydrogel can be dried and further processed. Control of the washing water pH and the drying conditions can be used to vary the important physical parameters, for example pore volume, pore size and the size of the surface of the resulting silica gel. The desired particle size (for example the d₅₀ value) and the desired particle size distribution (for example the SPAN98) are obtained by suitable grinding of the silica gel (for example mechanically or hydromechanically). Such particles can be obtained, for example, via Grace, Fuji, Degussa or Ineos.

It has been found to be advantageous to use particles having an average particle diameter d₅₀ of from 2.0 to 8 μm, preferably from 2.5 to 7 μm and more preferably from 3.0 to 6 μm. When particles having a diameter which is below 2.0 μm are used, there is under some circumstances no positive influence of the particles on the removal performance of the film from the tray. In this case, the film again tends to start to tear or continue to tear on removal from the tray, which is of course undesired. Particles having a diameter greater than 8 μm generally cause filter problems.

In a further preferred embodiment, the diameter d₅₀ of particles in the outer layer (A) is greater than the thickness of this layer. It has been found to be favorable to select a diameter/layer thickness ratio of preferably at least 1.1, in particular at least 1.3 and more preferably at least 1.5. In these cases, there is a particularly positive influence of the particles on the removal performance of the film from the tray.

To provide the desired peeling properties, it has been found to be advantageous for the heatsealable and peelable outer layer (A) to contain particles in a concentration of from 1.0 to 10% by weight. The concentration of particles is preferably from 2.5 to 10.0% by weight and more preferably from 4.0 to 10.0% by weight. In contrast, when the outer layer (A) contains particles in a concentration of less than 1.0% by weight, there is generally no longer any positive influence on the removal performance of the film from the tray. In contrast, when the outer layer (A) of the film contains particles in a concentration of more than 10% by weight, the opacity of the film becomes too great.

It has been found to be particularly advantageous to use particles in the heatsealable and peelable outer layer (A) whose particle diameter distribution has a degree of scatter which is described by a SPAN98 of ≦2.0 (definition of SPAN98, see test method). Preference is given to a SPAN98 of ≦1.9 and particular preference to a SPAN98 of ≦1.8. In contrast, when the outer layer (A) of the film comprises particles whose SPAN98 is greater than 2.0, the optical properties and the sealing properties of the film deteriorate.

Moreover, it has been found to be advantageous to adjust the roughness of the heatsealable and peelable outer layer (A) in such a way that its Rₐ value is preferably greater than 60 nm. The roughness Rₐ is in particular greater than 80 nm and it is more preferably greater than 100 nm; the upper limit of the roughness should not exceed 400 nm, preferably 350 nm, in particular 300 nm. This can be controlled via the selection of the particle diameters, their concentration and the variation of the layer thickness.

In order to further improve the processing performance of the film of the present invention, it is advantageous likewise to incorporate particles into the base layer (B) in the case of a two-layer film structure (AB), or into the nonsealable outer layer (C) in the case of a three-layer film structure (ABC), in which case the following conditions are preferably to be observed:
a) The particles should have an average particle diameter d₅₀ (=median) of from 1.5 to 6 μm. It has been found to be particularly appropriate to use particles having an average particle diameter d₅₀ of from 2.0 to 5 μm and more preferably from 2.5 to 4 μm.
b) The particles should be present in a concentration of from 0.1 to 1.0% by weight. The concentration of the particles is preferably from 0.12 to 1.0% by weight and more preferably from 0.15 to 1.0% by weight.

To achieve the aforementioned properties, especially the optical properties of the sealable and peelable layer, it has been found to be appropriate, especially in the case of a three-layer film with ABC structure, to set the amount of particles in the base layer (B) at a lower level than in the outer layer (A). In the three-layer film of the type mentioned, the amount of particles in the base layer (B) should appropriately be between 0 and 2.0% by weight, preferably between 0 and 1.5% by weight, in particular between 0 and 1.0% by weight. It has been found to be particularly appropriate to incorporate only particles into the base layer which get into the film via the same type of regrind (recyclate). The optical properties of the film, especially the opacity of the film, are then particularly good.

In an alternative embodiment, the base layer (B) and/or if appropriate, another additional layer comprises at least one white pigment and optionally an optical brightener.

Suitable white pigments are preferably titanium dioxide, barium sulfate, calcium carbonate, kaolin, silicon dioxide, of which preference is given to titanium dioxide and barium sulfate.

The titanium dioxide particles may include anatase or rutile, preferably predominantly rutile which exhibits a higher hiding power in comparison to anatase. In a preferred embodiment, the titanium dioxide particles include to an extent of at least 95% by weight of rutile. They may be prepared by a customary process, for example by the chloride or the sulfate process. Their amount in the base layer is appropriately from 0.1 to 25.0% by weight, preferably from 0.2 to 23.0% by weight and in particular from 0.3 to 22.0% by weight, based on the weight of the base layer. The average particle size is relatively small and is preferably in the range from 0.10 to 0.30 mm.

If desired, the film comprises barium sulfate as a pigment instead of titanium dioxide, in which case the concentration of the barium sulfate is preferably between 0.1% by weight and 25% by weight, more preferably between 0.2 and 23% by weight, in particular between 0.3 and 22% by weight, based on the weight of the base layer. Preference is also given to metering the barium sulfate directly in the film production via masterbatch technology.

In a further preferred embodiment, precipitated barium sulfate types are used. Precipitated barium sulfate is obtained from barium salts and sulfates or sulfuric acid as a finely divided colorless powder whose particle size can be controlled by the precipitation conditions. Precipitated barium sulfates may be prepared by the customary processes which are described in Kunststoff-Journal 8, No. 10, 30-36 and No. 11, 31-36 (1974).

The average particle size is relatively small and is preferably in the range from 0.1 to 5 μm, more preferably in the range from 0.2 to 3 μm. The density of the barium sulfate used is preferably between 4 and 5 g/cm³.

The film optionally comprises an optical brightener, in which case the optical brightener is used in amounts of preferably from 0 to 5% by weight, in particular from 0.002 to 3% by weight, more preferably from 0.005 to 2.5% by weight, based on the weight of the base layer. The optical brightener is preferably also metered directly in the film production via masterbatch technology.

The inventive optical brighteners are capable of absorbing UV rays in the range from 360 to 380 nm and emitting them again as longer-wavelength, visible blue-violet light. Suitable optical brighteners are, for example, bisbenzoxazoles, phenylcoumarins and bis-stearylbiphenyls, in particular phenylcoumarin; particular preference is given to triazinephenylcoumarin (TINOPAL®, Ciba-Geigy, Basle, Switzerland), HOSTALUX® KS (Clariant, Germany) and EASTOBRITE® OB-1 (Eastman).

The inventive film preferably contains from 0.0010 to 5% by weight of an optical brightener which is soluble in the crystallizable thermoplastic.

Where appropriate, it is also possible to add polyester-soluble blue dyes in addition to the optical brightener. Suitable blue dyes have been found to be, for example, cobalt blue, ultramarine blue and anthraquinone dyes, in particular SUDAN BLUE® 2 (BASF, Ludwigshafen, Federal Republic of Germany).

The blue dyes are used in amounts of preferably from 10 to 10 000 ppm, in particular from 20 to 5000 ppm, more preferably from 50 to 1000 ppm, based on the weight of the crystallizable thermoplastic.

According to the invention, titanium dioxide or the barium sulfate, the optical brightener and, where appropriate, the blue dye may already have been metered in by the manufacturer of the thermoplastic raw material or may be metered into the extruder in the course of film production via masterbatch technology.

Particular preference is given to adding the titanium dioxide or the barium sulfate, the optical brightener and, where appropriate, the blue dye via masterbatch technology. The additives are fully dispersed in a solid carrier material. Useful carrier materials include the thermoplastic itself, for example the polyethylene terephthalate, or else other polymers which are sufficiently compatible with the thermoplastic.

It is advantageous when the particle size and the bulk density of the masterbatch(es) are similar to the particle size and the bulk density of the thermoplastic, so that a homogeneous distribution and therefore a homogeneous whiteness and thus a homogeneous opacity are achieved.

Between the base layer and the outer layers may optionally be disposed another intermediate layer. This may in turn include the polymers described for the base layer. In a particularly preferred embodiment, the intermediate layer includes the polyesters used for the base layer. The intermediate layer may also comprise the customary additives described below. The thickness of the intermediate layer is generally greater than 0.3 μm and is preferably in the range from 0.5 to 15 μm, in particular in the range from 1.0 to 10 μm, more preferably in the range from 1.0 to 5 μm.

In the case of the two-layer and the particularly advantageous three-layer embodiment of the inventive biaxially oriented polyester film, the thickness of the outer layer (A) is preferably in the range from 1.0 to 7.0 μm, in particular in the range from 1.3 to 6.5 μm and more preferably in the range from 1.6 to 6.0 μm. When the thickness of the outer layer (A) is more than 7.0 μm, the peeling force rises markedly and is no longer within the preferred range. Furthermore, the peeling performance of the film is impaired. In contrast, when the thickness of the outer layer (A) is less than 0.8 μm, the film is generally no longer heatsealable.

The thickness of the other, nonsealable outer layer (C) may be the same as the outer layer (A) or different; its thickness is generally between 0.5 and 5 μm.

The total thickness of the inventive polyester film may vary within wide limits. It is preferably from 3 to 200 μm, in particular from 4 to 150 μm, preferably from 5 to 100 μm, and the layer (B) has a proportion of preferably from 45 to 97% of the total thickness.

The base layer and the other layers may additionally comprise customary additives, for example stabilizers (UV, hydrolysis), flame-retardant substances or fillers. They are appropriately added to the polymer or to the polymer mixture before the melting.

The present invention also provides a process for producing the film. To produce the inventive heatsealable and peelable outer layer (A), the particular polymers (polyester I, polyester II, optionally polyester-incompatible polymer [anti-PET polymer], masterbatch(es) for particles, etc.) are appropriately fed directly to the extruder for the outer layer (A). The materials can be extruded at from about 200 to 260° C. From a process engineering point of view (mixing of the different components), it has been found to be particularly favorable for the extrusion of the polymers for the outer layer (A) to be carried out using a twin-screw extruder having degassing means.

The polymers for the base layer (B) and for any further outer layer (C) present and, if appropriate, the intermediate layer are appropriately fed to the (coextrusion) system via further extruders. The melts are shaped to flat melt films in a multilayer die and layered one on top of the other. Subsequently, the multilayer film is drawn off with the aid of a chill roll and, if appropriate, further rolls and solidified.

According to the invention, the biaxial stretching of the film is carried out simultaneously. The temperature at which the stretching is carried out may vary within a relatively wide range and depends upon the desired properties of the film. In general, the stretching is carried out within a temperature range of from 70 to 140° C. The longitudinal stretching ratio is preferably in the range from 2.0:1 to 5.5:1, in particular from 2.3:1 to 5.0:1. The transverse stretching ratio is preferably in the range from 2.4:1 to 5.0:1, in particular from 2.6:1 to 4.5:1. For the simultaneous stretching, any simultaneous stretching plant with state-of-the-art operation is suitable in principle. Examples of such simultaneous stretching plants are published in the following documents: U.S. Pat. No. 4,675,582, U.S. Pat. No. 4,825,111, U.S. Pat. No. 4,853,602, U.S. Pat. No. 4,922,142, U.S. Pat. No. 5,036,262, U.S. Pat. No. 5,051,225, U.S. Pat. No. 5,072,493 and U.S. Pat. No. 5 416 959.

Before stretching, one or both surfaces of the film may be coated inline by the processes known per se. The inline coating may lead, for example, to improved adhesion between a metal layer or a printing ink and the film, to an improvement in the antistatic performance, the processing performance or else to a further improvement in the barrier properties of the film. The latter is achieved, for example, by applying barrier coatings such as EVOH, PVOH or the like. In that case, preference is given to applying such layers to the nonsealable surface, for example the surface (C) of the film.

In the subsequent heat-setting, the film is kept at a temperature of preferably from 150 to 250° C. over a period of from about 0.1 to 10 s. Subsequently, the film is wound up in a customary manner.

The gloss of the film surface (B) in the case of a two-layer film, or the gloss of the film surface (C) in the case of a three-layer film, is preferably greater than 100 (measured to DIN 67530 based on ASTM-D 523-78 and ISO 2813 with angle of incidence 20°). In a preferred embodiment, the gloss of these sides is more than 110 and, in a particularly preferred embodiment, more than 120. These film surfaces are especially suitable for a further functional coating, for printing or for metallization.

The opacity of the film is preferably less than 20%. In a preferred embodiment, the opacity of the film is less than 16% and in a particularly preferred embodiment less than 12%.

A further advantage of the invention is that the production costs of the inventive film are not significantly above those of a film made of standard polyester. In addition, it is guaranteed that, in the course of production of the film, offcut material which arises intrinsically in the operation of film production can be reused for film production as regrind in an amount of up to approx. 60% by weight, preferably from 5 to 50% by weight, based in each case on the total weight of the film, without the physical properties of the film being significantly adversely affected.

The inventive film is outstandingly suitable, for example, for packaging foods and other consumable goods, in particular for packaging foods and other consumable goods in trays in which peelable polyester films are used to open the package.

The table below (table 1) once again summarizes the most important preferred film properties.

TABLE 1

| | Inventive | | More | | Test |
|---|---|---|---|---|---|
| | range | Preferred | preferred | Unit | method |
| Outer layer (A) | | | | | |
| Proportion of units in the inventive polyester | 12 to 89 | 30 to 84 | 40 to 82 | mol % | |
| formed from aromatic dicarboxylic acids | | | | | |
| Proportion of units in the inventive polyester | 11 to 88 | 16 to 70 | 18 to 60 | mol % | |
| formed from aliphatic dicarboxylic acids | | | | | |
| Polyester I | 0 to 50 | 5 to 45 | 10 to 40 | % by wt. | |
| Polyester II | 50 to 100 | 55 to 95 | 60 to 90 | % by wt. | |
| Particle diameter d₅₀ | 2.0 to 8 | 2.5 to 7 | 3.0 to 6 | μm | |
| Filler concentration | 1.0 to 10.0 | 2.5 to 10.0 | 4.0 to 10.0 | % by wt. | |
| Thickness of the outer layer A | 1.0 to 7.0 | 1.3 to 6.5 | 1.6 to 6.0 | μm | |
| Particle diameter/layer thickness ratio | >/=1.1 | >/=1.3 | >/=1.5 | | |
| Properties | | | | | |
| Thickness of the film | 3 to 200 | 4 to 150 | 5 to 100 | μm | |
| Minimum sealing temperature of OL (A) against | 165 | 160 | 155 | ° C. | |
| PET trays | | | | | |
| Seal seam strength of OL (A) against PET trays | 1.5 to 8 | 2.0 to 8 | 2.5 to 8 | N/15 mm | |
| Gloss of the outer layers A and C | >70 and | >75 and | >80 and | | DIN |
| | >100 | >110 | >120 | | 67530 |
| Opacity of the film | <20 | <16 | <12 | % | ASTM D |
| | | | | | 1003-52 |

OL: outer layer,
>/=: greater than/equal to

To characterize the raw materials and the films, the following test methods were used for the purposes of the present invention:

Measurement of the Average Diameter d₅₀

The determination of the average diameter d₅₀ was carried out by means of laser on a Malvern Master Sizer (from Malvern Instruments Ltd., UK) by means of laser scanning (other measuring instruments are, for example, Horiba LA 500 or Sympathec Helos, which use the same measuring principle). To this end, the samples were introduced together with water into a cuvette and this was then placed in the measuring instrument. The dispersion is scanned by means of a laser and the signal is used to determine the particle size distribution by comparison with a calibration curve. The particle size distribution is characterized by two parameters, the median value d₅₀ (=measure of the position of the average value) and the degree of scatter, known as the SPAN98 (=measure of the scatter of the particle diameter). The measuring procedure is automatic and also includes the mathematical determination of the d₅₀ value. The d₅₀ value is determined by definition from the (relative) cumulative curve of the particle size distribution: the point at which the 50% ordinate value cuts the cumulative curve provides the desired d₅₀ value (also known as median) on the abscissa axis.

Measurement of SPAN98

The determination of the degree of scatter, the SPAN98, was carried out with the same measuring instrument as described above for the determination of the average diameter d₅₀. The SPAN98 is defined as follows:

$$SPAN98 = \frac{{d}_{98} - {d}_{10}}{{d}_{50}}$$

The basis of the determination of d₉₈ and d₁₀ is again the (relative) cumulative curve of the particle size distribution (see above “Measurement of the average diameter d₅₀”). The point at which the 98% ordinate value cuts the cumulative curve provides the desired d₉₈ value directly on the abscissa axis and the point at which the 10% ordinate value cuts the cumulative curve provides the desired d₁₀ value on the abscissa axis.

SV Value

The SV value of the polymer was determined by the measurement of the relative viscosity (ηᵣₑₗ) of a 1% solution in dichloroacetic acid in an Ubbelohde viscometer at 25° C. The SV value is defined as follows: SV=(ηᵣₑₗ₋1)·1000.

Glass Transition Temperatures T_{g}

The glass transition temperature T_{g} was determined using film samples with the aid of DSC (differential scanning calorimetry). The instrument used was a Perkin-Elmer DSC 1090. The heating rate was 20 K/min and the sample weight approx. 12 mg. In order to eliminate the thermal history, the samples were initially preheated to 300° C., kept at this temperature for 5 minutes and then subsequently quenched with liquid nitrogen. The thermogram was used to find the temperature for the glass transition T_{g} as the temperature at half of the step height.

Seal Seam Strength (Peeling Force)

To determine the seal seam strength, a film strip (100 mm long×15 mm wide) is placed on the APET side of an appropriate strip of the APET/CPET tray and sealed at the set temperature of ≧140° C., a sealing time of 0.5 s and a sealing pressure of 3 bar (HSG/ET sealing unit from Brugger, Germany, sealing jaw heated on both sides). In accordance with FIG. 2, the sealed strips are clamped into the tensile testing machine (for example from Zwick, Germany) and the 180° seal seam strength, i.e. the force required to separate the test strips, was determined at a removal rate of 200 mm/min. The seal seam strength is quoted in N per 15 mm of film strip (e.g. 3 N/15 mm).

Determination of the Minimum Sealing Temperature

The Brugger HSG/ET sealing unit as described above for the measurement of the seal seam strength is used to produce heatsealed samples (seal seam 15 mm×100 mm), and the film is sealed at different temperatures with the aid of two heated sealing jaws at a sealing pressure of 3 bar and a sealing time of 0.5 s. The 180° seal seam strength was measured as for the determination of the seal seam strength. The minimum sealing temperature is the temperature at which a seal seam strength of at least 1 N/15 mm is attained.

Roughness

The roughness Rₐ of the film was determined to DIN 4768 at a cutoff of 0.25 mm. It was not measured on a glass plate, but rather in a ring. In the ring method, the film is clamped into a ring, so that neither of the two surfaces touches a third surface (for example glass).

Opacity

The opacity according to Hölz was determined to ASTM-D 1003-52.

Gloss

The gloss of the film was determined to DIN 67530. The reflector value was measured as a characteristic optical parameter for the surface of a film. Based on the standards ASTM-D 523-78 and ISO 2813, the angle of incidence was set to 20°. A light beam hits the flat test surface at the angle of incidence set and is reflected or scattered by it. The light beams incident on the photoelectronic detector are displayed as a proportional electrical quantity. The measurement is dimensionless and has to be quoted together with the angle of incidence.

Tensile Strain at Break

The tensile strain at break of the film was measured to DIN 53455. The testing rate is 1%/min; 23° C.; 50% relative humidity.

Modulus of Elasticity

The modulus of elasticity of the film was measured to DIN 53457. The testing rate is 1%/min; 23° C; 50% relative humidity.

The invention is illustrated hereinbelow with reference to examples.

### EXAMPLE 1

Chips of polyethylene terephthalate are fed to the extruder for the base layer (B). Chips of polyethylene terephthalate and particles are likewise fed to the extruder (twin-screw extruder) for the nonsealable outer layer (C). In accordance with the process conditions listed in the table below, the raw materials are melted and homogenized in the two respective extruders.

In addition, a mixture including polyester I, polyester II and SiO₂ particles is prepared for the heatsealable and peelable outer layer (A). In Table 2, the particular proportions of the dicarboxylic acids and glycols present in the two polyesters I and II in mol % and the particular proportions of the components present in the mixture in % by weight are specified. The mixture is fed to the twin-screw extruder with degassing for the sealable and peelable outer layer (A). In accordance with the process conditions detailed in the table below, the raw materials are melted and homogenized in the twin-screw extruder.

By coextrusion in a three-layer die, the three melt streams are then layered one on top of the other and ejected via the die lip. The resulting melt film is cooled and a transparent, three-layer film having ABC structure is subsequently produced in a total thickness of 25 μm by a simultaneous stretching in longitudinal and transverse direction. The thickness of the outer layer (A) is 3.0 μm (cf. also Table 2).

Outer layer (A), mixture of:
20.0% by weight of polyester I (=copolymer of 78 mol % of ethylene terephthalate, 22 mol % of ethylene isophthalate) having an SV value of 850. The glass transition temperature of polyester I is approx. 75° C. Polyester I additionally contains 20.0% by weight of SYLYSIA® 430 (synthetic SiO₂, Fuji, Japan) having a particle diameter of d₅₀=3.4 μm;
80% by weight of polyester II (=copolymer containing 40 mol % of ethylene azelate, 50 mol % of ethylene terephthalate, 10 mol % of ethylene isophthalate) having an SV value of 1000. The glass transition temperature of polyester II is approx. 0° C.

Base layer (B):
100% by weight of polyethylene terephthalate having an SV value of 800

Outer layer (C), mixture of:
85% by weight of polyethylene terephthalate having an SV value of 800;
15% by weight of a masterbatch of 99% by weight of polyethylene terephthalate (SV value of 800) and 1.0% by weight of SYLOBLOC® 44 H (synthetic SiO₂, Grace, Worms), d₅₀=2.5 μm, SPAN98=1.9.

The production conditions in the individual process steps are:

| | | | | |
|---|---|---|---|---|
| Extrusion | Temperatures | A layer: | 230 | ° C. |
| | | B layer: | 280 | ° C. |
| | | C layer: | 280 | ° C. |
| | Temperature of the | | 20 | ° C. |
| | takeoff roll | | | |
| Simultaneous | Heating temperature | | 70-100 | ° C. |
| stretching | | | | |
| | Stretching | | 102 | ° C. |
| | temperature | | | |
| | Longitudinal | | 3.8 | |
| | stretching ratio | | | |
| | Transverse stretching | | 4.0 | |
| | ratio | | | |
| Setting | Temperature | | 230 | ° C. |
| | Time | | 3 | s |

Table 3 shows the properties of the film. According to measurements (column 2), the minimum sealing temperature of the film with respect to the APET side of APET/CPET trays is 120° C. The film is sealed to the APET side of APET/CPET trays at 140, 160, 180 and 200° C. (sealing pressure 4 bar, sealing time 0.5 s). Subsequently, strips of the bond of inventive film and APET/CPET tray are pulled apart by means of a tensile strain tester in accordance with the aforementioned test method (cf. FIG. 2). For all sealing temperatures, the films exhibit the desired peeling off from the tray according to FIG. 3b. The seal seam strengths are listed in column 3. For all sealing temperatures, peelable films are obtained. The seal seam strengths with respect to APET at approx. 5 N/15 mm are within the medium range, i.e. the films can be removed from the tray without great force being applied. In addition, the film had the required good optical properties, and exhibit the desired handling and processing performance.

### EXAMPLE 2

In comparison to example 1, the outer layer thickness of the sealable layer (A) is raised from 3.0 to 4.0 μm with similar film structure and otherwise identical production method. Polyester I now contains 20.0% by weight of SYLYSIA® 440 (synthetic SiO₂, Fuji, Japan) having a particle diameter of d₅=5.0 μm. The minimum sealing temperature of the film with respect to the APET side of APET/CPET trays is now 118° C. For all sealing temperatures, the films exhibit the desired peeling off from the tray according to FIG. 3b. The seal seam strengths measured are listed in column 3. For all sealing temperatures, peelable films are again obtained. The seal seam strengths of the inventive films are somewhat higher than in example 1. However, they are still in the medium range, so that the film can be removed from the tray without great force being applied. A somewhat lower opacity of the film is measured; the handling and the processing performance of the film are as in example 1.

### EXAMPLE 3

In comparison to example 2, the composition of polyester II for the sealable outer layer (A) is changed with otherwise identical film structure. The mixture used in outer layer (A) now includes the following raw material proportions:
30% by weight of polyester I, identical to example 1;
60% by weight of polyester II, VITEL® 1912,(Polyester, Bostik-Findley, USA; contains the dicarboxylic acid constituents azelaic acid, sebacic acid, terephthalic acid, isophthalic acid and further dicarboxylic acids in the approximate molar ratio of 40/1/45/10/4 and, as the diol component, at least 60 mol % of ethylene glycol). The glass transition temperature of polyester II is approx. −1° C.;
10% by weight of COC (TOPAS® 8007, Ticona, Frankfurt; an ethylene/norbornene COC having a T_{g} of approx. 75° C.).

The minimum sealing temperature of the film produced in accordance with the invention with respect to the APET side of APET/CPET trays is now 125° C. For all sealing temperatures, the films exhibit the desired peeling off from the tray according to FIG. 3b. The seal seam strengths are listed in column 3. For all sealing temperatures, peelable films are again obtained. The handling and the processing performance of the film are as in example 1.

### COMPARATIVE EXAMPLE 1

Example 1 from EP-A 0 379190 was reproduced. Table 3 shows the properties of the film. A peelable film was not obtained for any of the sealing temperatures specified. When the film was removed from the tray, the film started to tear immediately and exhibited a force-distance diagram according to FIG. 3a. The film exhibits “weldable” behavior and is thus unsuitable for the achievement of the object specified.

### COMPARATIVE EXAMPLE 2

Example 22 from EP-A 0 379190 was reproduced. Table 3 shows the properties of the film. A peelable film was not obtained for any of the sealing temperatures specified. When the film was removed from the tray, the film started to tear immediately and exhibited a force-distance diagram according to FIG. 3a. The film exhibits “weldable” behavior and is thus unsuitable for the achievement of the object specified.

### COMPARATIVE EXAMPLE 3

Example 1 from WO 02/059186 A1 was reproduced. Table 3 shows the properties of the film. A peelable film with respect to CPET was not obtained for any of the sealing temperatures specified. When the film was removed from the tray, the peeling force was too small.

The composition of the films is summarized in table 2, the film properties measured in table 3.

TABLE 2

| | | | | | | | | | | | | | | | PI/PII/ |
|---|---|---|---|---|---|---|---|---|---|---|---|---|---|---|---|
| | | | | | | | | | | | | | | | anti-PET |
| | | | | | | | | | | | | | | PI/PII/ | polymer |
| | | Composition of | | | | | | | | | | | | anti-PET | glass |
| | | polyester I | | | | Composition of polyester II | | | | | | | | polymer | transition |
| | | TA | IA | EG | NG | AzA | SeA | AdA | TA | IA | EG | BD | FA | ratios | temperatures |
| | | mol % | | | | mol % | | | | | | | | % by wt. | ° C. |
| Examples | 1 | 78 | 22 | 100 | | 40 | | | 50 | 10 | 100 | | | 20/80/0 | 75/0/ |
| | 2 | 78 | 22 | 100 | | 40 | | | 50 | 10 | 100 | | | 20/80/0 | 75/0/ |
| | 3 | 78 | 22 | 100 | | 40 | 1 | | 45 | 10 | >60 | | 4 | 30/60/10 | 75/−1/75 |
| Comparative | 1 | 82 | 18 | 100 | | — | — | — | — | — | — | — | — | 100/0/0/ | 75 |
| Examples | 2 | — | — | — | | | 10 | | 90 | | 100 | | | 0/100/0/ | approx. 50 |
| | 3 | | | | | | 50 | | 50 | | | 100 | | 0/100/0/ | −40 |

| | | | | Outer layer | | Particles in (A) | | | |
|---|---|---|---|---|---|---|---|---|---|
| | | | Film | thicknesses | | | SPAN | | |
| | | Film | thickness | (A) | (C) | Diameter | 98 | Concentration | d₅₀/d_{(A)} |
| | | structure | μm | μm | | μm | — | % | ratio |
| Examples | 1 | ABC | 25 | 3 | 1 | 3.4 | 1.8 | 4.00 | 1.13 |
| | 2 | ABC | 25 | 4 | 1 | 5 | 1.8 | 4.00 | 1.25 |
| | 3 | ABC | 25 | 2.5 | 1 | 3.4 | 1.8 | 6.00 | 1.36 |
| Comparative | 1 | AB | 20 | 3 | — | 1.5 + 5 | — | 0.3 | 1.68 |
| Examples | 2 | AB | 17.2 | 4.1 | — | — | — | — | — |
| | 3 | AB | 25.0 | 1.5 | — | | | | |

TA terephthalate, IA isophthalate, EG ethylene, BD butane, NG neopentylglycol AzA azelate, SeA sebacate, AdA adipate, FA further dicarboxylic acids and glycols

TABLE 3

| | | Minimum | Seal seam strength with | | | | Seal seam strength with | | | |
|---|---|---|---|---|---|---|---|---|---|---|
| | | sealing | respect to APET/CPET trays | | | | respect to CPET trays | | | |
| | | temperature | 140° C. | 160° C. | 180° C. | 200° C. | 140° C. | 160° C. | 180° C. | 200° C. |
| | | ° C. | N/15 mm | | | | N/15 mm | | | |
| Examples | 1 | 120 | 4 | 4.7 | 5 | 5.2 | 3.4 | 3.9 | 4.2 | 4.6 |
| | 2 | 118 | 5 | 5.6 | 6.8 | 7 | 4.3 | 4.2 | 5.2 | 5 |
| | 3 | 125 | 3.5 | 4 | 4.7 | 5.7 | 3 | 3.4 | 4 | 5 |
| CE | 1 | 109 | 4.2 | 5.5 | 8.1 | — | 13 | 110 | 190 | 69 |
| CE | 2 | 112 | 2 | 4 | 6 | — | 4 | 150 | 190 | 33 |
| CE | 3 | 110 | 3 | 3.4 | 4 | — | 1.5 | 1.6 | 1.9 | 2.4 |

| | | Peeling | | | | Roughness Rₐ | |
|---|---|---|---|---|---|---|---|
| | | test (=peeling | Opacity | Gloss | | Side A | Side C |
| | | performance) | % | Side A | Side C | nm | |
| Examples | 1 | ++++ | 5 | 120 | 130 | 169 | 60 |
| | 2 | ++++ | 4 | 122 | 130 | 175 | 60 |
| | 3 | ++++ | 10 | 88 | 130 | 212 | 60 |
| CE | 1 | − | 25 | | | 75 | AB |
| CE | 2 | − | 20 | | | approx. | AB |
| | | | | | | 50 | |
| CE | 3 | − | 6 | | | | |

Peeling test:
++++: At all sealing temperatures, film is peeled from the tray without the film starting or continuing to tear. Impeccable, smooth, clean peeling of the film from the tray, even in the upper temperature range at high seal seam strength.
−: At all sealing temperatures, film starts to tear on removal from the tray

1. A process for producing a biaxially oriented poly-ester film which has a base layer (B) and has a heatsealable outer layer (A) that can be peeled from polyester, where the outer layer (A) comprises from 60 to 99% by weight of polyester which is composed of from 12 to 89 mol % of units derived from at least one aromatic dicarboxylic acid and of from 11 to 88 mol % of units derived from at least one aliphatic dicarboxylic acid, where the sum of the molar percentages is 100, said process comprising the steps of
a) coextruding at least the base layer (B) and of the outer layer (A) to give an unoriented film,
b) simultaneously, biaxially stretching the unoriented film, and
c) heat-setting the stretched film.

2. The process as claimed in claim 1, wherein the thickness of the outer layer (A) is from 1 to 7 μm.

3. The process as claimed in claim 1, wherein the simultaneous, biaxial stretching takes place at from 70 to 140° C.

4. The process as claimed in claim 1, wherein the longitudinal stretching ratio is from 2.0:1 to 5.5:1 and the transverse stretching ratio is from 2.4:1 to 5.0:1.

5. The process as claimed in claim 1, wherein the film is kept at a temperature of from 150 to 250° C. for from 0.1 to 10 s during the heat-setting process.

6. The process as claimed in claim 1, wherein the aromatic dicarboxylic acids of the polyester of the outer layer (A) have been selected from one or more of the following substances: terephthalic acid, isophthalic acid, and 2,6-naphthalenedicarboxylic acid.

7. The process as claimed in claim 1, wherein the aliphatic dicarboxylic acids of the polyester of the outer layer (A) have been selected from one or more of the following substances: succinic acid, pimelic acid, suberic acid, azelaic acid, sebacic acid, glutaric acid, and adipic acid.

8. The process as claimed in claim 1, wherein the polyester of the outer layer (A) contains from 12 to 89 mol % of terephthalate, from 0 to 25 mol % of isophthalate, from 11 to 88 mol % of azelate, from 0 to 50 mol % of sebacate, from 0 to 50 mol % of adipate, and more than 30 mol % of ethylene or butylene, based in each case on total dicarboxylate and, respectively, total amount of alkylene.

9. The process as claimed in claim 1, wherein the outer layer (A) has a minimum sealing temperature of not more than 165° C. for sealing against APET/CPET or CPET trays.

10. The process as claimed in claim 1, wherein the outer layer (A) has a seal seam strength of at least 1.5 N/15 mm of film width against APET/CPET or CPET trays.

11. The process as claimed in claim 1, wherein the polyester of the outer layer (A) is prepared from two polyesters I and II.

12. The process as claimed in claim 1, wherein the polyester I is composed of one or more aromatic dicarboxylates and of one or more aliphatic alkylenes.

13. The process as claimed in claim 11, wherein the polyester I contains terephthalate units, isophthalate units, and ethylene units.

14. The process as claimed in claim 11, wherein the proportion of the polyester I in the outer layer (A) is from 0 to 50% by weight.

15. The process as claimed in claim 11, wherein the polyester I has a glass transition temperature above 50° C.

16. The process as claimed in claim 11, wherein the polyester II is composed of one or more aliphatic dicarboxylates and of one or more aromatic dicarboxylates, and of one or more aliphatic alkylenes.

17. The process as claimed in claim 11, wherein the polyester II contains azelate units, terephthalate units, isophthalate units, and ethylene units.

18. The process as claimed in claim 11, wherein the proportion of the polyester II in the outer layer (A) is from 50 to 100% by weight.

19. The process as claimed in claim 11, wherein the polyester II has a glass transition temperature below 20° C.

20. The process as claimed in claim 1, wherein the outer layer (A) comprises inorganic and/or organic particles.

21. The process as claimed in claim 1, wherein the outer layer (A) comprises a polymer incompatible with polyester.

22. The process as claimed in claim 1, wherein the film has three layers and has an A-B-C structure.

23. The process as claimed in claim 1, wherein the base layer (B) is composed of at least 80% by weight of thermoplastic polyester.

24. The process as claimed in claim 1, wherein the polyester of the base layer (B) contains terephthalate units and/or isophthalate units, and ethylene units.

25. The process as claimed in claim 20, wherein the particles are present at a concentration of from 1 to 10% by weight.

26. The process as claimed in claim 21, wherein the polymer incompatible with polyester is a cyclo-olefin copolymer.
